(19) United States
(12) Patent Application Publication
(10) Pub. No.: US 2008/0077778 A1
(43) Pub. Date: Mar. 27, 2008

(54) Method and Apparatus for Register Renaming in a Microprocessor

(76) Inventors: Gordon T. Davis, Chapel Hill, NC (US); Richard W. Doing, Raleigh, NC (US); John D. Jabusch, Cary, NC (US); M V V Anil Krishna, Cary, NC (US); Brett Olsson, Cary, NC (US); Eric F. Robinson, Raleigh, NC (US); Sumedh W. Sathaya, Cary, NC (US); Jeffrey R. Summers, Raleigh, NC (US)

Correspondence Address: IBM CORPORATION, PO BOX 12195, DEPT YXSA, BLDG 002, RESEARCH TRIANGLE PARK, NC, 27709, US

(21) Appl. No.: 11/534,711

(22) Filed: Sep. 25, 2006

(51) Int. Cl. G06F 9/30

(52) U.S. Cl. 712/217

(57) ABSTRACT

Register renaming as contemplated by this invention allows processor hardware to use a larger set of registers than the architected registers visible to the compiler. This larger set of registers is called the physical register file. Thus, dynamically renaming every compiler-suggested architected register to a microarchitecture-specific physical register, allows the processor to overcome name dependencies and the hazards (pipeline slowdowns) induced by name dependencies. The invention here described differs from prior renaming techniques in that it extracts significant benefit from renaming with a fraction of the number of physical registers previously used for this process. The invention therefore also simplifies the logic involved in supporting the use of the physical registers.

### FIELD AND BACKGROUND OF INVENTION

Assembly code generated by compilers often does not make the best use of the registers available to it. Often, insufficient register resources as provided by the architecture force the compiler to reuse register names where it otherwise would not have. This leads to various types of data dependencies between instructions, which in turn could lead to data hazards in the processor, thereby slowing down execution by reducing the effectiveness of out-of-order execution capabilities. In a processor that executes instructions in-order the only data dependencies that can arise are pure dependencies.

The value of a register is defined in one instruction and used in a following instruction. In the case of a pure dependency, a latter instruction must wait for the former to define the register. These dependencies are not resolved by more intelligently using the available registers. In processors that execute instructions out-of-order, two other types of data dependencies can occur—anti-dependencies and output dependencies. Both these types of data dependencies are name dependencies and can be resolved either by using the register set more efficiently or by using a larger set of registers than are provided by the processor's architecture. Register dependencies lead to data hazards, which reduce the instruction level parallelism that can be achieved by a processor, and therefore reduce its performance.

Existing techniques for handling data hazards introduced by out-of-order execution typically use a large set of physical registers and a relatively large renaming and mapping logic to assign physical register names to architected registers in an instruction. The main goal of these prior techniques is improving performance by extracting all possible Instruction Level Parallelism that exists in conventional programs. This performance gain comes at the cost of area, logic and power. The present invention seeks to alleviate this costs where the latter are primary optimization targets and performance improvement is being maximized within allowed bounds of area, logic and power.

### SUMMARY OF THE INVENTION

Register renaming as contemplated by this invention and described more fully hereinafter is a technique to overcome name dependencies to a significant extent by utilizing many fewer physical registers and less supporting logic than has been used in prior system for register renaming. It allows the processor hardware to use a larger set of registers than the architected registers visible to the compiler. This larger set of registers is called the physical register file. Thus, dynamically renaming every compiler-specified architected register to a microarchitecture-specific physical register, allows the processor to overcome name dependencies and the hazards (pipeline slowdowns) induced by name dependencies.

The invention here described differs from prior renaming techniques in that it extracts significant benefit from renaming with a fraction of the number of physical registers previously used for this process. The invention therefore also simplifies the logic involved in supporting the use of the physical registers.

### BRIEF DESCRIPTION OF DRAWINGS

Some of the purposes of the invention having been stated, others will appear as the description proceeds, when taken in connection with the accompanying drawings, in which:

FIG. 1 is a schematic representation of the operative coupling of a computer system central processor and layered memory which has level 1, level 2 and level 3 caches and DRAM; and

FIGS. 2 through 6 illustrate register renaming as described hereinafter.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

The term “programmed method”, as used herein, is defined to mean one or more process steps that are presently performed; or, alternatively, one or more process steps that are enabled to be performed at a future point in time. The term programmed method contemplates three alternative forms. First, a programmed method comprises presently performed process steps. Second, a programmed method comprises a computer-readable medium embodying computer instructions which, when executed by a computer system, perform one or more process steps. Third, a programmed method comprises a computer system that has been programmed by software, hardware, firmware, or any combination thereof to perform one or more process steps. It is to be understood that the term programmed method is not to be construed as simultaneously having more than one alternative form, but rather is to be construed in the truest sense of an alternative form wherein, at any given point in time, only one of the plurality of alternative forms is present.

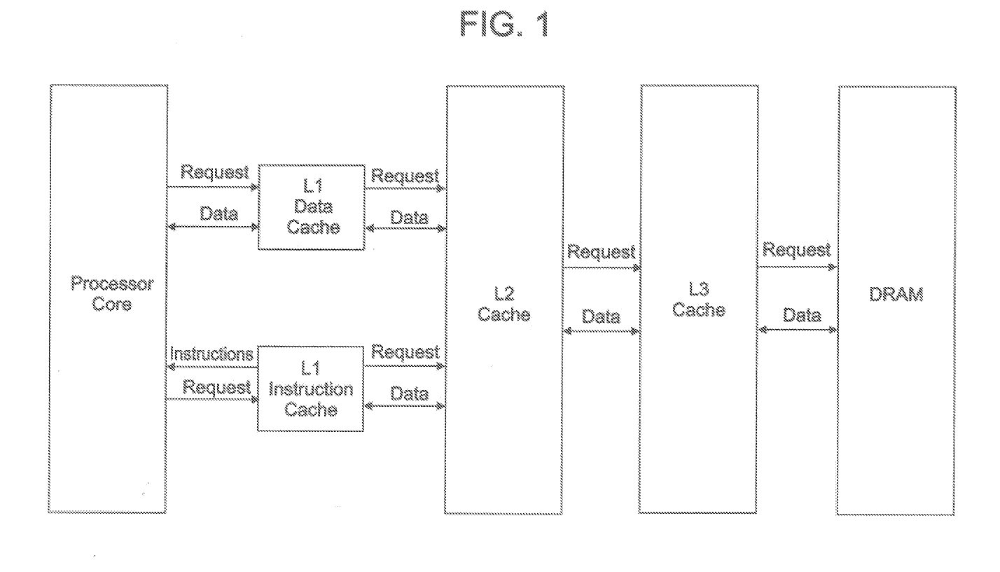

A context relevant to the invention here described is a computer system having a central processor and layered memory operatively associated with the central processor. The layered memory, as contemplated by this invention, may have a plurality of levels of cache storage, as indicated in FIG. 1. The layered memory may have level one, two and three cache storage. This technology is generally well known in computer system architecture and will not here be described in greater detail. The interested reader is referred to numerous available texts which describe the cooperation between a processor and such layered memory. The layered memory cooperates with registers internal to the processor in creating a “pipeline” for instructions to be executed by the processor. It is this pipeline which is a particular focus of this invention.

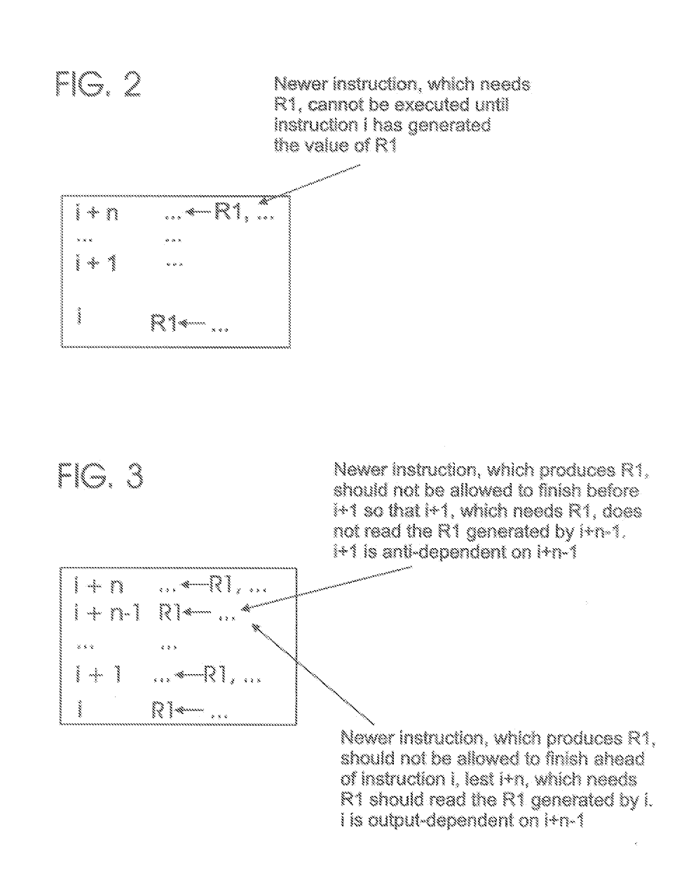

Note: Example instruction sequences in this document follow the following rules:
Without loss of generality, the format of instructions is chosen to be Ra, Rb, Rc.
There are 2 source operands, Rb and Rc, and one destination operand, Ra.
An operation is performed on those operands to generate the 1 result that goes into the destination operand. The operation code (opcode) is not shown.
The operands are not shown in the figures, since they are not critical to the ideas presented.
Only the Register being focused on, for purposes of disclosure, is depicted in FIGS. 2 through 5. The remaining pieces of an instruction are represented by ellipses.
The left side of any instruction sequence example provides an instruction number, to confirm the program order. All examples use a program order such that an instruction is older than the instruction above it.

Instructions in a program have data dependencies that limit the maximum instruction level parallelism achievable by the microprocessor (hardware) or the compiler (software). These dependencies may be one or more of several types.

Pure Dependency: An instruction that depends on a value generated by a previous instruction has to wait till the microprocessor has computed that value, before proceeding. This is called a pure dependency (FIG. 2).

Name Dependencies: In an attempt to increase parallel execution of instructions, modern superscalar microprocessor's dependence-check hardware looks at a window of instructions and issues the ones that have no dependencies among themselves or with the ones already under execution. This leads to out-of-order execution, where, even if an older instruction is prevented from dispatch due to a dependency, a newer instruction may dispatch and therefore execute to completion before the older instruction. Such execution leads to two other types of data dependencies, which, therefore lead to two other types of stall conditions.

The destination register of a currently active older instruction might be the same as the destination register of a newer instruction. Currently active implies that the instruction is either stalled, waiting for its sources, or is currently under execution. In other words, it has not written back the value to its destination register. The newer instruction could be dispatched for execution if it has all its source operands available, and could finish ahead of the older instruction. This creates, firstly, a situation where the instructions that are pure-dependent on the older instruction, could now read their source operand to be the value provided by the new instruction. Secondly, this creates a situation where instructions pure-dependent on the newer instruction, could read the value provided by the older instruction when it finishes. The first scenario arises due to an anti-dependence between the newer instruction and the pure-dependents of the older instruction. The second scenario arises due to an output-dependence between the older and the newer instructions writing to the same destination register (FIG. 3).

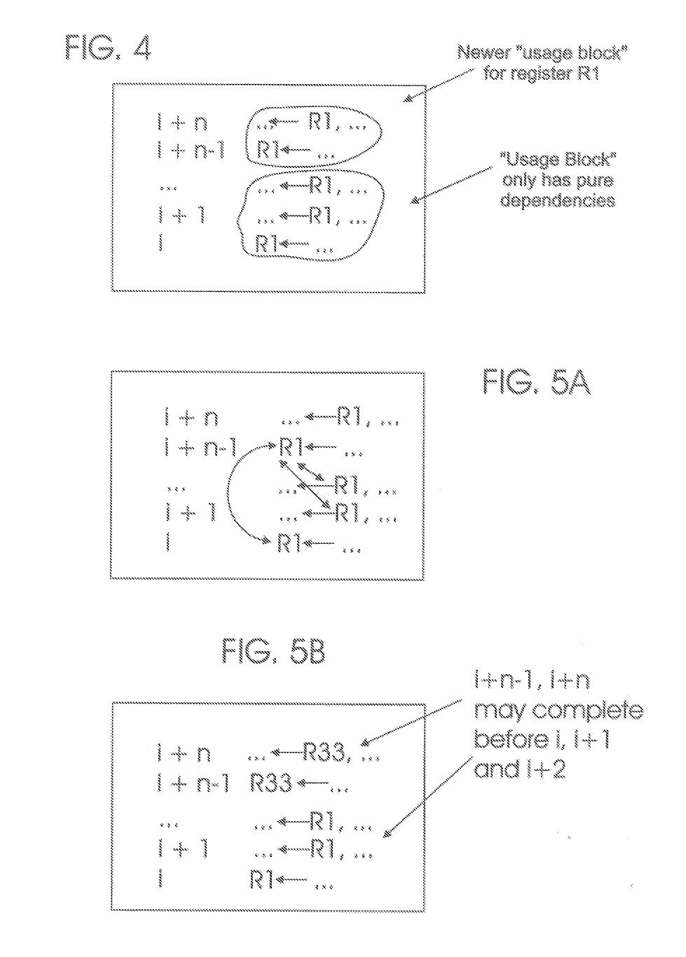

Anti and output dependence are called name dependencies, and are not true dependencies. The prior attempts at avoiding such dependencies leading to inaccurate execution have been by using different physical registers for each “usage block” that can overlap in execution due to their proximity. A “usage block” is a term used to indicate a sequence of instructions starting with the write of a register followed by all its uses, until the next write of that register (FIG. 4). In addition to providing extra temporary storage to hold results from instructions executed out-of-order, hardware techniques like scoreboarding, Tomasulo's ReOrder Buffer, History File or Future File assure that the architected state of the processor is updated in program-order. It is crucial to update the architected state of the system in program-order in order to handle asynchronous interrupts, something beyond the scope of this discussion. This extra storage provided by hardware is also called physical registers, and the technique of reassigning registers to be used by an instruction is called register renaming. The mechanisms to remember the mapping currently in use between the architected and physical register file and the mechanisms to assure in-order update of the architected state are relatively independent of the mechanisms for register renaming.

The prior solutions for register-renaming allow an architected register to be renamed to any available physical register, and allow any number of renames to be active at the same time for a given architected register, provided the physical registers (renames) are available. So as an example, in a processor with 32 architected registers, and 128 renames (physical registers), architected register R1 can be renamed as P1 or P2 or P3, and so on till P128, where P indicated Physical Register. R2 can be renamed as P1, P2, and so on till P128, depending on the availability of a given rename. This provides a great flexibility to renaming, but comes at the cost of greater area for the physical registers, complicated logic to search for and access available renames, maintaining bigger rename maps, and logic to be able to update every architected register from any of the physical registers.

This invention restricts the number of renames available to a given architected register to a smaller set of physical registers, thus providing limited flexibility of renaming and yet, providing much simpler renaming logic with significantly lesser area and power consumption.

Register Renaming is a hardware technique applied in many high performance microprocessors, that execute instructions out-of-order, to achieve greater Instruction Level Parallelism. Typically Register Renaming involves renaming the Architected Register names in an instruction (generated by the compiler) to Physical Register names. Physical Registers comprise a set of hardware registers, typically twice or greater in number than the hardware registers required by the Architecture (Architected Registers).

Register renaming in its most generalized form requires an any-to-any mapping between the architected registers and the physical registers. An architected register is renamed to one of the available physical registers. This invention contemplates another renaming scheme, which uses a significantly smaller number of physical registers. Register renaming removes name dependencies. Register renaming typically involves the use of a significantly larger number of registers available than the architected registers. Register renaming involves using the available registers in a fashion different from what the compiler might have suggested, in order to decrease name dependencies, and thereby allows more efficient and possibly out-of-order instruction processing.

Logic in the front end of the microprocessor looks up the next available Physical Register and renames all the uses of a register in a “usage block” from a unique architected register name to a unique physical register name. This operation is done in program order to identify the “usage block” accurately. Since name dependencies traverse “usage block” boundaries, they are removed by renaming (FIG. 5a and FIG. 5b).

After renaming, an instruction waits for the source operands to be available and then proceeds to the execution units, possibly out-of-program-order. Pure dependencies exist within a “usage block” and might still cause stalling for the dependent instructions. After the result is generated by an instruction, it is written to the physical register file. The program order is remembered in a structure called the reorder buffer or a completion buffer, which is updated with the information that an instruction has completed every time an instruction writes its destination physical register. The reorder buffer cycles through and commits the value of the oldest completed instruction to the architected register using the mapping information it maintains or obtains.

Instead of a generalized renaming scheme where an architected register can be renamed as and mapped to any available physical register, this invention uses a limited renaming scheme where a limited number of architected registers (for example, 8 out of 32) have a limited number of allowable renames each (for example, 2 renames).

The space, logic and time complexity of maintaining the state of the physical register file, ascertaining the availability of a mapping, and the actual mapping, is significantly reduced compared to generalized renaming. The drawback over a full-blown renaming scheme is that there is the possibility that due to unavailability of the physical register resources associated with a particular architected register, instructions get stalled in the renaming stage and dynamic instruction scheduling slows down. But this invention provides a significant advantage over an in-order machine by allowing the instructions some leeway in proceeding ahead of a previous instruction that is using the same architected register as its target.

As an example, in a 32 register PowerPC Architecture, a small plurality, say only the first 4 and the last 4, of architected registers would have this limited renaming option. Each of those 8 registers would have a small plurality, say 2, of possible renames. The other 24 architected registers will not be renamed. This hardware limitation is supported by the observation that the compilers for the target applications and market segment make use of the extremities of the architected register file much more than the middle values. For compilers that distribute the register usage better, there will inherently be fewer name dependencies and therefore lesser need for renaming. This invention therefore provides a hardware assist in renaming when the compiler falls short of fully utilizing the available register set.

The invention has three main components. First, a small number of physical registers and a limited number of rename options are provided for each architected register. Second, extra information must be maintained for each of the physical registers to make the processor work accurately. Third, the extra physical registers and the extra information stored per physical register are used to achieve accurate processor execution.

Instead of providing double or more than double the number of architected registers as physical registers, only a small number of physical registers, typically a little more than the total architected registers, are required for the mechanism disclosed here. The number of physical registers depends on the number of architected registers which have renames. Not all architected registers are required to have multiple renames. Only some architected registers have more than one corresponding physical register, and the number of such corresponding physical registers is also a small number. An embodiment might allow the first and last four architected registers to have two physical registers each, while the rest of the architected registers only have one physical register each. Which architected registers have an opportunity to be renamed to multiple physical registers depends upon how the most commonly used compilers and operating system for the given architecture typically utilize the available architected registers to assign registers to instructions in a binary.

To make this technique work, some extra state information that must be maintained per physical register file. Information needs to be maintained in the physical register to indicate if it is the rename that is being currently used for the corresponding architected register. A “latest” bit is maintained per physical register to indicate if it was the last rename associated with a particular architected register. Information must also be maintained to indicate if the physical register that is the latest rename is ready for use. In case an instruction wants to read the physical register (the physical register is the source operand) it must make sure there is no outstanding write to that physical register. To indicate that there is an outstanding write, an “Outstanding Write Bit” (OWB) is maintained per physical register. If this bit is set, the instruction has to wait before its source operand is ready, and therefore its issue to the functional units is stalled. If an instruction has completed execution it updates the physical register corresponding to its target (or destination) operand.

Before an instruction is allowed to update the destination operand there must be a way for the instruction to make sure that all reads of the physical register are over. This requires an indication to be maintained by each physical register that indicates if there are outstanding “uses” or reads for it. This is maintained by a “use-vector”. The “use-vector” is a one-hot-encoding for each of the stages of the pipeline that will use that register. This encoding is available at the time an instruction is decoded and is updated at the time an instruction is renamed, dispatched or issued. In a different embodiment the use-vector may only be a count of the number of outstanding requests waiting to use the physical register's value.

An instruction is fetched and decoded first. The instruction moves to the dispatch window. A rename is assigned to its source and destination registers using the appropriate “latest” bits indicating the freshest renames. If no renames are available for the destination register (the destination registers OWB bit is 1 or use-vector is non-zero), the instruction stalls in the dispatch or rename stage. An entry is made in a ReOrder Buffer or completion queue to keep track of the program-order in which the instructions arrived. If the instruction is not stalled it marks the OWB of the destination register to 1 and moves to the next stage of the pipeline, say the issue stage, containing storage for instructions as they are prepared for issue to the functional units. These storages have historically been called reservation stations. Physical registers corresponding to the source registers are looked up to see if the data is available. Data is assumed available if there is no outstanding write (OWB bit is 0) and is then read in to the reservation station. If there is an outstanding write (OWB bit is 1), then the source operand is not available. The instruction marks the “use-vector” corresponding to the source physical register to indicate that there is an instruction which will use the data when it becomes available and the instruction waits in the reservation station. Once all source operands are available for a certain instruction it is issued to the functional units. Once the instruction completes, the result is sent to the physical register, and OWB is marked 0 for that physical register. The dependent instructions waiting on the data from this physical register are provided the data, and the use-vector bits are appropriately marked 0. The instruction is marked as complete in the ReOrder Buffer. Note that this need not be the oldest instruction in the ReOrder Buffer and therefore the instruction completion could be happening out-of-order. The ReOrder Buffer commits instructions which have been marked complete, in program-order. The architected register corresponding to the destination physical register is updated for each of the completed instructions.

The following is an example implementation of the technology presented above:

Taking the example of the PowerPC Architecture and assuming that the renaming is being applied to the Fixed Point Unit's 32 General Purpose Registers (GPRs) and assuming that there are 8 stages in the processor's pipeline from which the GPRs may be accessed, it turns out that the physical register file maintains 19 bits of extra information for each architected register that has two renames. In this example, for architected registers 1, 2, 3, 4, 29, 30, 31 and 32 two physical registers, also termed renames, are maintained. For registers 5 though 28, 10 bits of extra information and only one physical register is maintained. Other implementations of this idea may rename more or fewer registers. Similar renaming may be applied to condition registers or other register types such as Floating Point registers or Vector registers.

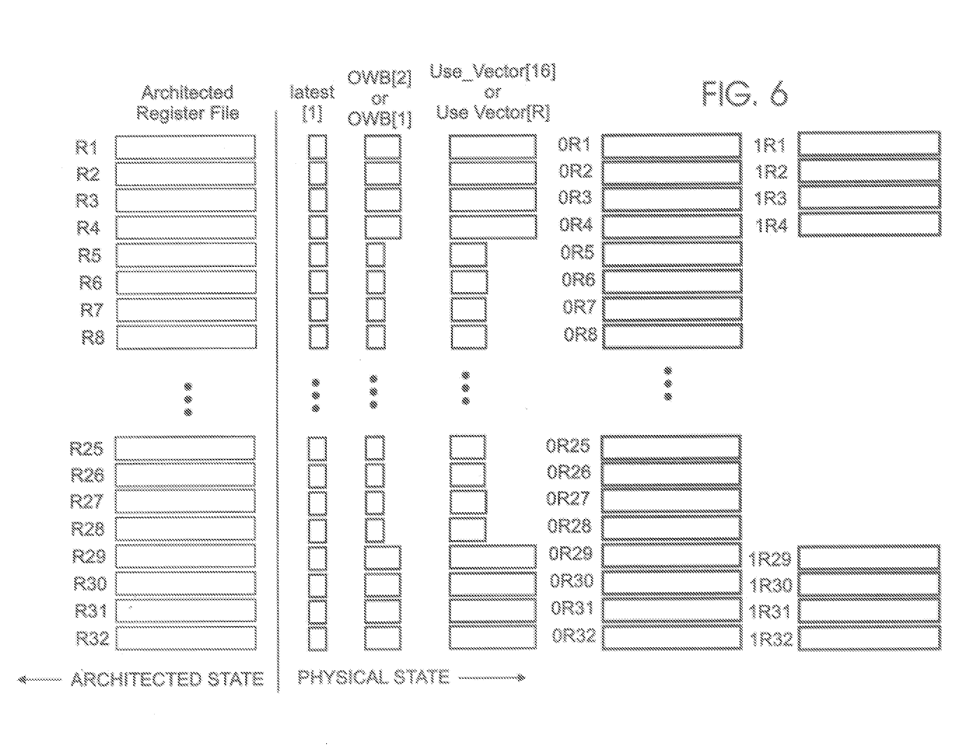

Each architected register has either 19 or 10 bits of information maintained for mapping purposes. These bits consist of:
“latest” bit—1 bit. For physical registers corresponding to architected registers 1-4 and 29-32, this bit indicates which of the two physical registers associated with the architected register should be used for renaming. This bit is consulted in the renaming stage of the microprocessor, in program order. It is used when a source operand in an instruction has to be renamed. It is set when a destination operand in an instruction must be renamed. For architected registers 5-28, since there is only 1 physical register per architected register, the latest bit always stays at 0 (FIG. 6).
More than one latest bit might be required if the idea is extended to more than 2 renames per register for certain registers. The “latest” bit need not be maintained for the registers which have only a single rename. These registers need not have physical register space allocated, since the architectural register is enough to serve the required purpose. (FIG. 6)
“OWB” bit—2 bits for registers 1-4 and 29-32, 1 bit for registers 5-28. OWB stands for Outstanding Write Bit, and when set, indicates that the physical register is expecting an active instruction to write to it. This is an indication for instructions that want to read its value, that the value is not ready yet. This bit is cleared after the instruction that is writing to this register has completed. The instruction need not commit its value to the architected register file for this bit to be cleared.
The number of bits needed for the “OWB” field may be more than 2 if the number of available renames for a particular register increases. One “OWB” bit is required per rename per register. The “OWB” bit need not be maintained for the registers which have only a single rename. These registers need not have extra physical register space allocated, since the architectural register is enough to serve the required purpose. (FIG. 6)
“use-vector bits”—16 bits for registers 1-4 and 29-32, 8 bits for registers 5-28. There are 8 use-vector bits maintained per physical register. These bits indicate if there is an active instruction that is waiting to use the value of the physical register. Each of the 8 bits is set from one of 8 possible pipeline stages that are capable of register access. The number of pipeline stages capable of register access varies by a processor's microarchitecture, and 8 is used here only as an example. The bits are cleared when an instruction, with that register as a source register, completes reading the value. The instruction need not commit its value to the architected register file for this bit to be cleared.
The number of bits needed for the “use-vector” field may be more than 16 if there are more than 2 renames available for a register. In this example scenario, the number of “use-vector” bits required would be 8 times the number of renames for a given register. The “use_vector” bits need not be maintained for the registers which have only a single rename.

Before the execution of the instructions in possibly out-of-order fashion starts in the pipeline, the renaming logic receives instructions in program order and renames every register that has a possible physical rename from architected to a physical name.

While this discussion describes two renames available for the first four and last four architected registers in the example explained here, the invention can be extended to any number of renames for each architected register. The number of bits required to maintain the state of the renames in use, grows as a factor of the number of renames made available to each architected register. For n renames, log2(n) “latest” bits are required to point to the rename in use, n “OWB” bits are required to keep track of which renames have an outstanding write to the physical register outstanding and 8n “use-vector” bits are required to keep track of the outstanding uses (or reads) of the physical register corresponding to the rename. The factor of 8 in the 8n mentioned here is also variable depending on the number of stages in the system's microarchitecture from where an instruction might try to read the physical register. Although this disclosure has chosen to use a “one-hot” encoded scheme for keeping track of the “use-vector”, even that stipulation may be relaxed and only log2(k) bits are required to keep a count of the number of outstanding uses, where k is the number of stages in the microarchitecture that can read from a physical register.

When an instruction arrives at the rename stage, its destination register is renamed, if possible, by first figuring out if a corresponding physical register is available. This involves making sure that both the OWB bit and the use-vector are 0 for a corresponding physical register. If the architected register being renamed is 1-4 or 29-32, there are two physical registers that are available. So for these registers, renaming is possible if either:

“OWB[0]==0 AND use-vector[0]==0” or

“OWB[1]==0 AND use-vector[1]==0”.

If neither of these conditions is satisfied, then a rename is unavailable. If both these conditions are satisfied, then both renames are available, and any one is chosen. It is contemplated that the use of the rename register be toggled compared to the last use. This information is available from the current value of the “latest” bit for that register. If 1, it is set to 0, and if 0, it is set to 1. If only one of these conditions is satisfied, then the rename that satisfies the condition is chosen. The “latest” bit is set to indicate the newly assigned rename. Therefore, for example, if R1 is the destination register of an instruction and both 0R1 and 1R1 renames are available, “latest” may be set to 0, and R1 would get renamed to 0R1. The OWB[latest] bit is set to 1. It retains this state till the instruction completes and updates the physical register file with the data.

The source registers have to be renamed according to the rename set for the register in a prior instruction where the register was the destination. In order to do that, the “latest” bit corresponding to the architected register of this source register is looked up and the rename corresponds to that bit. So if the “latest” bit is 1 then R1 would be renamed 1R1. Also, the use-vector[latest] must be updated by a 1 in the bit position corresponding to the pipeline stage that does the register access.

The architected registers are, under normal operation, only written to. They are read when a context switch, interrupt or other atypical supervisor-mode intervention is required. They are updated in program-order that is maintained by a structure called the ReOrder Buffer. As the oldest, uncommitted instruction in program-order completes, its destination physical register's value is written to its corresponding architected register.

In the drawings and specifications there has been set forth a preferred embodiment of the invention and, although specific terms are used, the description thus given uses terminology in a generic and descriptive sense only and not for purposes of limitation.

What is claimed is:

1. Apparatus comprising:
a computer system central processor;
a plurality of architected registers operatively associated with said processor and providing therefor at least one operand to instructions in the processor pipeline; and
a renaming capability operatively associated with said processor and said registers which assigns a restricted number of physical register names to a restricted number of predetermined architected registers.

2. Apparatus according to claim 1 wherein said architected registers comprises a predetermined number of registers and further wherein said renaming capability is restricted to assigning physical register names to those ones among said architected registers that are a limited range of lowest numbers and a limited range of highest numbers of said architected registers.

3. Apparatus according to claim 2 wherein said ones among said architected registers that are in the limited ranges comprise one fourth of the predetermined number of architected registers.

4. Apparatus according to claim 1 wherein said renaming capability maintains for assigned physical register names information bits indicative of the state of respective registers.

5. Apparatus according to claim 4 wherein said renaming capability uses maintained information bits to facilitate out-of-order processing of instructions while maintaining a correct architected machine state for said processor.

6. Method comprising:
coupling together a computer system central processor and layered memory accessible by the central processor;
defining a plurality of architected registers operatively associated with said processor and providing therefor at least one operand to instructions in the processor pipeline; and
assigning a restricted number of physical register names to a restricted number of predetermined architected registers.

7. Method according to claim 6 wherein the defining of the architected registers identifies a predetermined number of registers and further wherein the assigning of physical register names is restricted to assigning physical register names to those ones among said architected registers that are a limited range of lowest numbers and a limited range of highest numbers of said architected registers.

8. Method according to claim 7 wherein the ones among said architected registers that are in the limited ranges comprise one fourth of the predetermined number of architected registers.

9. Method according to claim 6 further comprising maintaining for assigned physical register names information bits indicative of the state of respective registers.

10. Method according to claim 9 further comprising using the maintained information bits to facilitate out-of-order processing of instructions while maintaining a correct architected machine state for said processor.

11. Programmed method comprising:
coupling together a computer system central processor and layered memory accessible by the central processor;
defining a plurality of architected registers operatively associated with said processor and providing therefor at least one operand to instructions in the processor instruction pipeline; and
assigning a restricted number of physical register names to a restricted number of predetermined architected registers.

12. Programmed method according to claim 11 wherein the defining of the architected registers identifies a predetermined number of registers and further wherein the assigning of physical register names is restricted to assigning physical register names to those ones among said architected registers that are a limited range of lowest numbers and a limited range of highest numbers of said architected registers.

13. Programmed method according to claim 12 wherein the ones among said architected registers that are in the limited ranges comprise one fourth of the predetermined number of architected registers.

14. Programmed method according to claim 12 further comprising maintaining for assigned physical register names information bits indicative of the state of respective registers.

15. Programmed method according to claim 14 further comprising using the maintained information bits to facilitate out-of-order processing of instructions while maintaining a correct architected machine state for said processor.
